(19) United States
(12) Patent Application Publication
(10) Pub. No.: US 2019/0215906 A1
(43) Pub. Date: Jul. 11, 2019

(54) SIGNALING TO SUPPORT REDUCED PROCESSING TIME

(71) Applicant: Intel IP Corporation, Santa Clara, CA (US)

(72) Inventors: Umesh Phuyal, San Diego, CA (US); Hong He, Sunnyvale, CA (US); Youn Hyoung Heo, Seoul (KR)

(73) Assignee: Intel IP Corporation, Santa Clara, CA (US)

(21) Appl. No.: 16/327,775

(22) PCT Filed: Oct. 24, 2017
(86) PCT No.: PCT/US2017/057985

§ 371 Date: Feb. 22, 2019

Related U.S. Application Data
(60) Provisional application No. 62/418,137, filed on Nov. 4, 2016.

(51) Int. Cl. H04W 88/02; H04W 72/14; H04L 1/18; H04W 76/27; H04W 88/08

(52) U.S. Cl. CPC H04W 88/023; H04W 72/14; H04W 88/08; H04W 76/27; H04L 1/1812

(57) ABSTRACT

An apparatus of a user equipment (UE) comprises one or more baseband processors to generate a message for an evolved NodeB (eNB) to indicate if the UE supports a reduced processing time for hybrid automatic repeat request (HARQ), and a memory to store the message.

### CROSS-REFERENCE TO RELATED APPLICATIONS

The present application claims the benefit of U.S. Provisional Application No. 62/418,137 (P111818Z) filed Nov. 4, 2016. Said Application No. 62/418,137 is hereby incorporated herein by reference in its entirety.

### BACKGROUND

In the Third Generation Partnership Project (3GPP), shortened transmission time interval (TTI) and processing time for long term evolution (LTE) is being considered. Such objectives may relate to shortened TTI operation and shortened processing time for both legacy (1 ms) TTI and shortened TTI for both the case of carrier aggregation and non-carrier aggregation and may include designs independent of frame structure.

For frame structure type (FS) 1, 2, and 3, a minimum timing n+3 is supported for uplink (UL) grant to UL data and for downlink (DL) data to DL hybrid automatic repeat request (HARQ) for user equipment (UE) devices capable of operating with reduced processing time with only the following conditions. A maximum timing advance (TA) is reduced to x ms, where x<=approximately 0.33 ms when scheduled by physical downlink control channel (PDCCH). Reduced processing times may be radio resource control (RRC) configured for the UE.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of reduced processing time for downlink HARQ in accordance with one or more embodiments;

FIG. 2 is a diagram of a network capable to indicate support for reduced processing time using Radio Resource Control (RRC) signaling in accordance with one or more embodiments;

FIG. 3 is a diagram of a network capable to indicate support for reduced processing time using System Information Block (SIB) signaling in accordance with one or more embodiments;

FIG. 4 is a diagram of a reduced processing time for uplink HARQ in accordance with one or more embodiments;

FIG. 5 is a diagram of a network including a UE to indicate is capability of support for reduced processing time using RRC reconfiguration signaling in accordance with one or more embodiments;

FIG. 6 illustrates an architecture of a system of a network in accordance with some embodiments;

FIG. 7 illustrates example components of a device 700 in accordance with some embodiments; and

FIG. 8 illustrates example interfaces of baseband circuitry in accordance with some embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

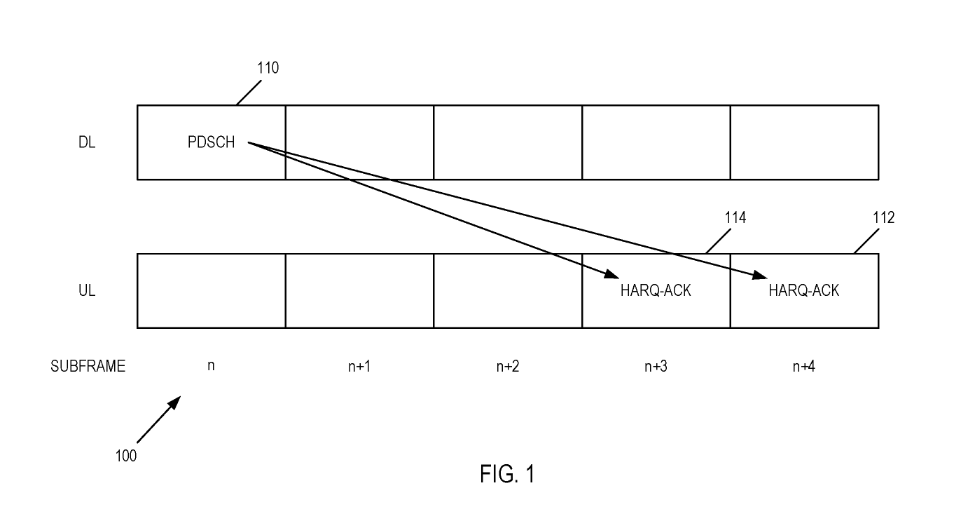

Referring now to FIG. 1, a diagram of reduced processing time for downlink hybrid automatic repeat request (HARQ) in accordance with one or more embodiments will be discussed. In diagram 100, downlink (DL) data may be transmitted in the physical downlink shared channel (PDSCH) 110 in subframe n. For a standard processing time network, it is expected that the HARQ feedback in the uplink (UL) such as the HARQ acknowledgment (HARQ-ACK) 112 should appear in frame n+4. For networks in which the serving cell and user equipment (UE) devices that support reduced processing time, it is expected that the HARQ feedback in the UL such as HARQ-ACK 114 should appear in frame n+3.

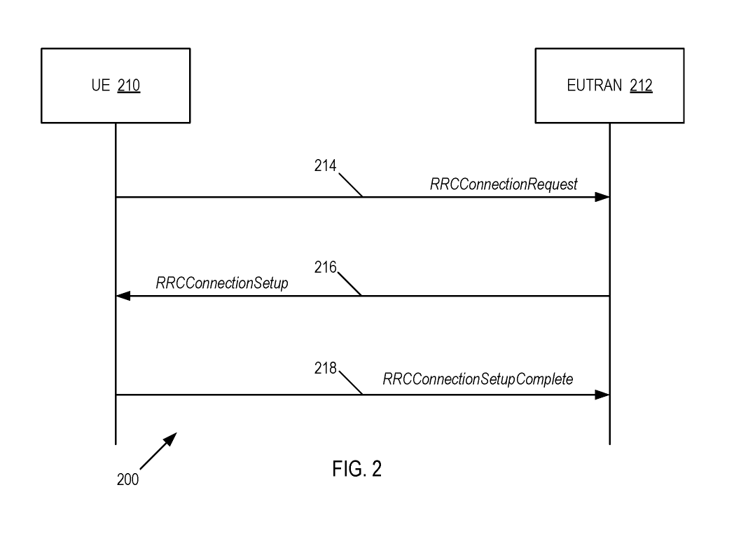

In one or more embodiments as discussed in further detail, below, the network may use signaling to indicate to the one or more UE devices whether the evolved NodeB (eNB) of the network supports reduced processing time. The network also may use signaling for how the eNB activates and/or configures reduced processing times for the one or more UE devices that support reduced processing time. In addition, reduced processing time may be signaled to the network using one or more UE capability bits or a combination of bits to support reduced processing time. Furthermore, a particular category of UE may inherently indicate to the network the capability indication to indicate to the network that the UE supports reduced processing time. An example of the network using Radio Resource Control (RRC) signaling to indicate that the network supports reduced processing time is shown in and described with respect to FIG. 2, below.

Referring now to FIG. 2, a diagram of a network capable to indicate support for reduced processing time using Radio Resource Control (RRC) signaling in accordance with one or more embodiments will be discussed. FIG. 2 shows a network 200 comprising one or more user equipment (UE) 210 devices and an evolved Universal Terrestrial Radio Access Network (EUTRAN) 212 comprising one or more evolved NodeB (eNB) devices to communicate with the UE 210. In one or more embodiments, the network 200 may support both types of UE 210 at the same time, namely UEs 210 configured to operate using n+4 processing time, and UEs 210 configured to operate using reduced n+3 processing time. The UEs 210 which support n+3 processing time may need to know whether network 200 supports n+3 processing time. In one embodiment, dedicated signaling such as RRC signaling may be used to indicate to the UEs 210 whether n+3 processing time is possible for the grants provided by the eNB of EUTRAN 212. For example, during RRC connection establishment, EUTRAN 212 may receive an RRCConnectionRequest message from UE 210. In reply, EUTRAN 212 may send an RRCConnectionSetup message 216 to UE 210, which may include information indicating to UE 210 whether EUTRAN 212 supports reduced processing time. Upon completion of the RRC connection, UE 210 may send an RRCConnectionSetupComplete message 218 to EUTRAN 212.

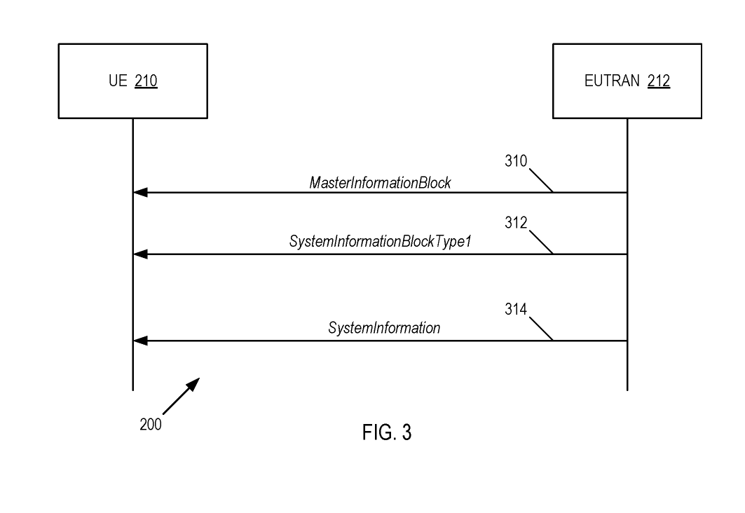

Referring now to FIG. 3, a diagram of a network capable to indicate support for reduced processing time using System Information Block (SIB) signaling in accordance with one or more embodiments will be discussed. In FIG. 3, broadcast signaling such as system information block (SIB) signaling may be used to indicate to the UEs 210 whether n+3 processing time is possible for the grants provided by the eNB of EUTRAN 212. In one embodiment, such broadcast signaling may be modeled as a Boolean information element (IE) in one of the legacy SIBs, such as in the Master Information Block (MIB) or System Information Block Type 1, or in a new System Information Block. As shown in FIG. 3, EUTRAN 212 may transmit MasterInformationBlock, SystemInformationBlockType1 312, or SystemInformation message 314 to UE 210 which may include information indicating whether EUTRAN 212 supports reduced processing time, although the scope of the claimed subject matter is not limited in this respect.

In one or more embodiments, network 200 also may use the process of FIG. 2 or FIG. 3 to configure one or more UEs 210 to use reduced processing time. Network 200 may support both types of UEs 210 at the same time, legacy UEs 210 with n+4 processing time, and UEs 210 with reduced n+3 processing time. Network 200 may configure the UEs 210 that are capable of supporting n+3 processing time to use n+3 based reduced processing time.

In a first embodiment, dedicated signaling such as RRC signaling such as shown in FIG. 2 may be used to configure the UEs 210 to use n+3 based processing time for the grants provided by the eNB of EUTRAN 212. In one embodiment, this may be modeled as a Boolean information element (IE) as shown below where underlining indicates changes to 3GPP technical specification (TS) 36.331 to implement configuration of one or more UEs 210 to use reduced processing time.

MAC-MainConfig information element

-- ASN1START

| | |
|---|---|
| MAC-MainConfig ::= | SEQUENCE { |

| <<skipped>> | |
|---|---|
| [[ skipUplinkTx-r14 | CHOICE { |

| | |
|---|---|
| release | NULL, |
| setup | SEQUENCE { |

| | | | |
|---|---|---|---|
| skipUplinkTxSPS-r14 | ENUMERATED {true} | OPTIONAL, | -- |

Need OR

| | | | |
|---|---|---|---|
| skipUplinkTxDynamic-r14 | ENUMERATED {true} | OPTIONAL | -- |

Need OR

}

| | | |
|---|---|---|
| } | OPTIONAL | --Need ON |

]],
[[ reducedProcessingTiming-v14xy BOOLEAN OPTIONAL --

Need ON

]]

}
<<skipped>>

MAC-MainConfig field descriptions

reducedProcessingTiming
TRUE indicates that the reduced processing
timing n+3 is supported for UL grant
to UL data and for DL data to DL HARQ
for UEs capable of operating with
reduced processing time as specified in [xx].

In another embodiment, broadcast signaling such as SIB signaling as shown in FIG. 3 may be used to configure to the UEs 210 to use n+3 based processing time for the grants provided by the eNB of EUTRAN 212. In one particular embodiment, broadcast signaling may be modeled as a Boolean IE in one of the legacy SIBs such as in the MIB or SIB Type1, or in a new SIB. although the scope of the claimed subject matter is not limited in this respect.

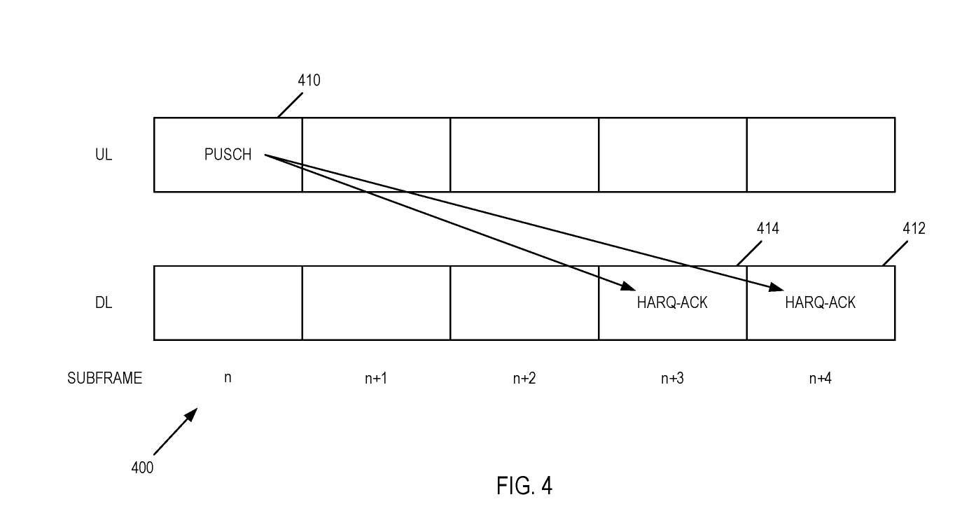

Referring now to FIG. 4, a diagram of a reduced processing time for uplink HARQ in accordance with one or more embodiments will be discussed. In diagram 400, uplink (UL) data may be transmitted in the physical uplink shared channel (PUSCH) 410 in subframe n. For a standard processing time network, it is expected that the HARQ feedback in the downlink (DL) such as the HARQ acknowledgment (HARQ-ACK) 412 should appear in frame n+4. For networks in which the serving cell and user equipment (UE) devices that support reduced processing time, it is expected that the HARQ feedback in the DL such as HARQ-ACK 414 should appear in frame n+3.

For synchronous HARQ, when the shortened processing time is supported by the UE 210 and the eNB of ETURAN 212, the synchronous HARQ round trip time (RTT) of n+8 may not be valid. Therefore, asynchronous HARQ may be utilized for the UL. Some embodiments and networks may relate to not using the Physical Hybrid ARQ Indicator Channel (PHICH-less) asynchronous HARQ for the UL for 1 ms TTI with shortened processing time. Furthermore, some embodiments may involve situations where for FS1 and FS2, bit fields are defined in the applicable downlink control information (DCI) messages to indicate HARQ processes identifier (ID) and redundancy version (RV).

In one embodiment, when the eNB of EUTRAN 212 supports reduced processing time, most or all the UEs 210 supporting reduced processing times use asynchronous HARQ in UL. In another embodiment, when the eNB of EUTRAN 212 supports reduced processing time, only the UEs 210 which support the reduced processing times and may be configured by the network 200 to use the reduced processing times use asynchronous HARQ in the UL.

When the processing time is reduced, the HARQ RTT may be reduced. New HARQ timing including HARQ RTT timers may be defined based on the reduced processing times. In one embodiment, the medium access control (MAC) specification may be updated to support asynchronous HARQ when reducedProcessingTiming is configured. The changes to the affected subclauses of 3GPP TS 36.321 are shown below in underlining.

5.4.2 HARQ Operation

5.4.2.1 HARQ Entity

«Skipped»

Uplink HARQ operation is asynchronous for serving cells operating according to Frame Structure Type 3, narrowband internet of things (NB-IoT) UEs, bandwidth reduced low complexity (BL) UEs, UEs supporting reduced processing time and configured with reducedProcessingTiming, or UEs in enhanced coverage except for the repetitions within a bundle.

«Skipped»

7.7 HARQ RTT Timers

For each serving cell, in case of frequency division duplex (FDD) configuration and in case of Frame Structure Type 3 configuration on the serving cell which carries the HARQ feedback for this serving cell the HARQ RTT Timer is set to 8 subframes. For each serving cell, in case of FDD configuration on the serving cell which carries the HARQ feedback for this serving cell for UEs supporting reduced processing time and configured with reducedProcessingTiming, the HARQ RTT Timer is set to 6 subframes. For each serving cell, in case of TDD configuration on the serving cell which carries the HARQ feedback for this serving cell the HARQ RTT Timer is set to k+4 subframes, except for UEs supporting reduced processing time and configured with reducedProcessingTiming, the HARQ RTT Timer is set to k+3 subframes, where k is the interval between the downlink transmission and the transmission of associated HARQ feedback, as indicated in subclauses 10.1 and 10.2 of [1], and for a relay node (RN) configured with rn-SubframeConfig [8] and not suspended, as indicated in Table 7.5.1-1 of [11].

«Skipped»

Except for NB-IoT, UL HARQ RTT Timer length is set to 4 subframes for FDD and Frame Structure Type 3, to 3 subframes for FDD and UEs supporting reduced processing time configured with reducedProcessingTiming, and set to k_{ULHARQRTT} subframes for time division duplex (TDD), where k_{ULHARQRTT} equals to the k_{PHICH} value indicated in Table 9.1.2-1 of [1].

«Skipped»

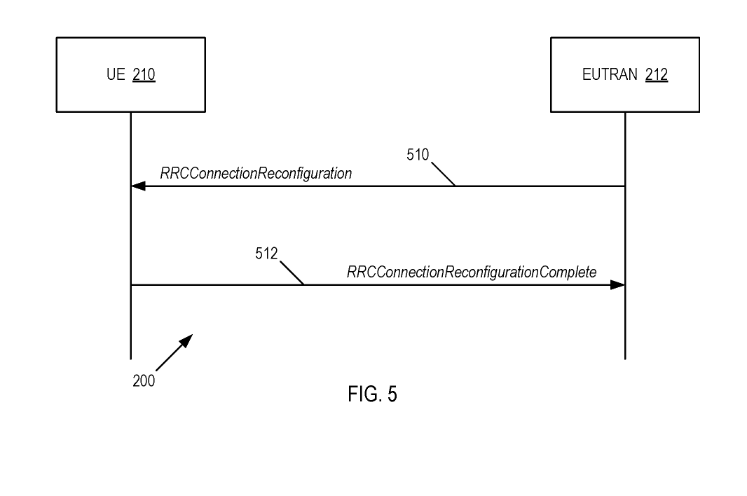

Referring now to FIG. 5, a diagram of a network including a UE to indicate is capability of support for reduced processing time using RRC reconfiguration signaling in accordance with one or more embodiments will be discussed. The network 200 may need to know whether the UE 210 is capable of supporting reduced processing time. In one embodiment, such capability for n+3 based processing may be mandated for all UEs 210 that are able to operate using reduced processing time. In other embodiments, the UE 210 may be allowed indicate that the UE has the capability to operate using reduced processing time.

In one embodiment, the UE 210 may indicate its capability to the network 200 using RRC capability indication techniques such as shown in FIG. 2 wherein the UE 210 may indicate its capability using an RRCConnectionRequest message 214. The changes involved for the UE 210 to provide its capability are shown below for 3GPP TS 36.331 subclause 6.3.6 with the added text indicated by underlining

UE-EUTRA-Capability information element

-- ASN1START
<<skipped>>
UE-EUTRA-Capabilily-v14xy-IEs ::= SEQUENCE {

| | | |
|---|---|---|
| laa-Parameters-v14xy | LAA-Parameters-v14xy | OPTIONAL, |

| latRed-Parameters-v14xy LatRed-Parameters-v14xy | | OPTIONAL, |
|---|---|---|
| nonCrilicalExtension | SEQUENCE { } | OPTIONAL |

}
<<skipped>>

| | |
|---|---|
| LatRed-Parameters-v14xy ::= | SEQUENCE { |

| | |
|---|---|
| reducedProcTiming-r14 ENUMERATED {supported} | OPTIONAL |

}
<<skipped>>
-- ASN1STOP

| | FDD/ |
|---|---|
| | TDD |
| UE-EUTRA-Capability field descriptions | diff |
| reducedProcTiming | — |
| Indicates UE is capable of operating with | |
| reduced processing time, i.e., it | |
| supports a timing of n+3 for UL grant to | |
| UL data and for DL data to DL | |
| HARQ. | |

In another embodiment, the UE indication may be provided in 3GPP TS 36.306 subclause 4.2 as a new subclause 4.3.xx may be introduced.

4.3.xx Latency Reduction parameters

4.3.xx.y reducedProcTiming -r14
This field indicates whether the UE is capable
of operating with reduced processing time, i.e.,
it supports a timing of n+3 for UL grant to UL
data and for DL data to DLHARQ, when configured
by E-UTRAN, as described in TS 36.321 [4].

In one or more embodiments, network 200 may send an indication to the UE 210 requesting information on one or more of supported processing times, for example by using an RRC reconfiguration message as shown in FIG. 5. For example, this information may be sent by EUTRAN 212 to UE 210 via RRCConnectionReconfiguration message 510. The UE 210 may then respond to EUTRAN 212 along with the requested information, for example using an RRCConnectionReconfigurationComplete message 512. Note that if the request message, for example RRCConnectionReconfiguration message 510, is lost for some reason, EUTRAN 212 may detect that the original message was lost and retransmit the request via another RRCConnectionReconfiguration message 510, although the scope of the claimed subject matter is not limited in this respect.

In another embodiment, a predefined class or the category of UEs 210 may be mapped to a predefined reduced processing time using any one or more of the techniques as described above. When a UE 210 indicates its class or category to EUTRAN 212 during an attach procedure, the EUTRAN 212 may implicitly know and determine the supported processing time based on class and/or category of the UE 210, and/or version of the 3GPP specification which the UE 210 supports.

In one or more embodiments, the EUTRAN 212 and UE 210 may support and perform signaling to use a processing time reduced based on other than an n+3 timing, for example based on an n+2 timing. Although the embodiments described herein were discussed for processing time reduction based on n+3 timing, the above embodiments also may be applicable for other processing time values, such as n+2 based or any other reduced processing time, and the scope of the claimed subject matter is not limited in this respect.

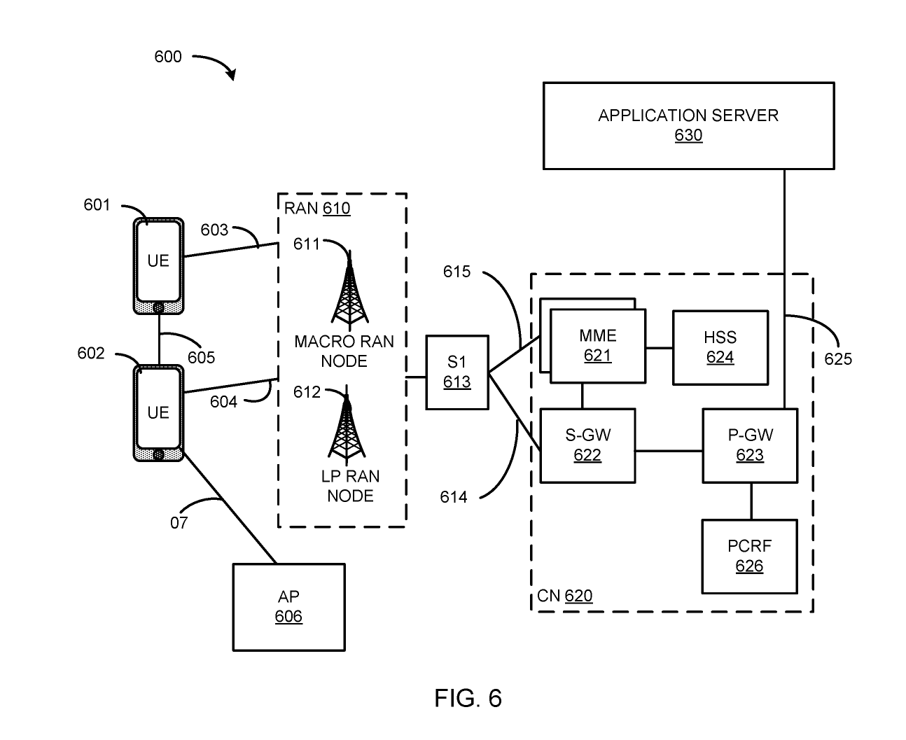

FIG. 6 illustrates an architecture of a system 600 of a network in accordance with some embodiments. The system 600 is shown to include a user equipment (UE) 601 and a UE 602. The UEs 601 and 602 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 601 and 602 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 601 and 602 may be configured to connect, e.g., communicatively couple, with a radio access network (RAN) 610—the RAN 610 may be, for example, an Evolved Universal Mobile Telecommunications System (UMTS) Terrestrial Radio Access Network (E-UTRAN), a NextGen RAN (NG RAN), or some other type of RAN. The UEs 601 and 602 utilize connections 603 and 604, respectively, each of which comprises a physical communications interface or layer (discussed in further detail below); in this example, the connections 603 and 604 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 601 and 602 may further directly exchange communication data via a ProSe interface 605. The ProSe interface 605 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 602 is shown to be configured to access an access point (AP) 606 via connection 607. The connection 607 can comprise a local wireless connection, such as a connection consistent with any IEEE 802.11 protocol, wherein the AP 606 would comprise a wireless fidelity (WiFi®) router. In this example, the AP 606 is shown to be connected to the Internet without connecting to the core network of the wireless system (described in further detail below).

The RAN 610 can include one or more access nodes that enable the connections 603 and 604. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 610 may include one or more RAN nodes for providing macrocells, e.g., macro RAN node 611, and one or more RAN nodes for providing femtocells or picocells (e.g., cells having smaller coverage areas, smaller user capacity, or higher bandwidth compared to macrocells), e.g., low power (LP) RAN node 612.

Any of the RAN nodes 611 and 612 can terminate the air interface protocol and can be the first point of contact for the UEs 601 and 602. In some embodiments, any of the RAN nodes 611 and 612 can fulfill various logical functions for the RAN 610 including, but not limited to, radio network controller (RNC) functions such as radio bearer management, uplink and downlink dynamic radio resource management and data packet scheduling, and mobility management.

In accordance with some embodiments, the UEs 601 and 602 can be configured to communicate using Orthogonal Frequency-Division Multiplexing (OFDM) communication signals with each other or with any of the RAN nodes 611 and 612 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-1-DMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 611 and 612 to the UEs 601 and 602, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 601 and 602. The physical downlink control channel (PDCCH) may carry information about the transport format and resource allocations related to the PDSCH channel, among other things. It may also inform the UEs 601 and 602 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 611 and 612 based on channel quality information fed back from any of the UEs 601 and 602. The downlink resource assignment information may be sent on the PDCCH used for (e.g., assigned to) each of the UEs 601 and 602.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 610 is shown to be communicatively coupled to a core network (CN) 620—via an S1 interface 613. In embodiments, the CN 620 may be an evolved packet core (EPC) network, a NextGen Packet Core (NPC) network, or some other type of CN. In this embodiment the S1 interface 613 is split into two parts: the S1-U interface 614, which carries traffic data between the RAN nodes 611 and 612 and the serving gateway (S-GW) 622, and the S1-mobility management entity (MME) interface 615, which is a signaling interface between the RAN nodes 611 and 612 and MMEs 621.

In this embodiment, the CN 620 comprises the MMEs 621, the S-GW 622, the Packet Data Network (PDN) Gateway (P-GW) 623, and a home subscriber server (HSS) 624. The MMEs 621 may be similar in function to the control plane of legacy Serving General Packet Radio Service (GPRS) Support Nodes (SGSN). The MMEs 621 may manage mobility aspects in access such as gateway selection and tracking area list management. The HSS 624 may comprise a database for network users, including subscription-related information to support the network entities' handling of communication sessions. The CN 620 may comprise one or several HSSs 624, depending on the number of mobile subscribers, on the capacity of the equipment, on the organization of the network, etc. For example, the HSS 624 can provide support for routing/roaming, authentication, authorization, naming/addressing resolution, location dependencies, etc.

The S-GW 622 may terminate the S1 interface 613 towards the RAN 610, and routes data packets between the RAN 610 and the CN 620. In addition, the S-GW 622 may be a local mobility anchor point for inter-RAN node handovers and also may provide an anchor for inter-3GPP mobility. Other responsibilities may include lawful intercept, charging, and some policy enforcement.

The P-GW 623 may terminate an SGi interface toward a PDN. The P-GW 623 may route data packets between the EPC network 623 and external networks such as a network including the application server 630 (alternatively referred to as application function (AF)) via an Internet Protocol (IP) interface 625. Generally, the application server 630 may be an element offering applications that use IP bearer resources with the core network (e.g., UMTS Packet Services (PS) domain, LTE PS data services, etc.). In this embodiment, the P-GW 623 is shown to be communicatively coupled to an application server 630 via an IP communications interface 625. The application server 630 can also be configured to support one or more communication services (e.g., Voice-over-Internet Protocol (VoIP) sessions, PTT sessions, group communication sessions, social networking services, etc.) for the UEs 601 and 602 via the CN 620.

The P-GW 623 may further be a node for policy enforcement and charging data collection. Policy and Charging Enforcement Function (PCRF) 626 is the policy and charging control element of the CN 620. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 626 may be communicatively coupled to the application server 630 via the P-GW 623. The application server 630 may signal the PCRF 626 to indicate a new service flow and select the appropriate Quality of Service (QoS) and charging parameters. The PCRF 626 may provision this rule into a Policy and Charging Enforcement Function (PCEF) (not shown) with the appropriate traffic flow template (TFT) and QoS class of identifier (QCI), which commences the QoS and charging as specified by the application server 630.

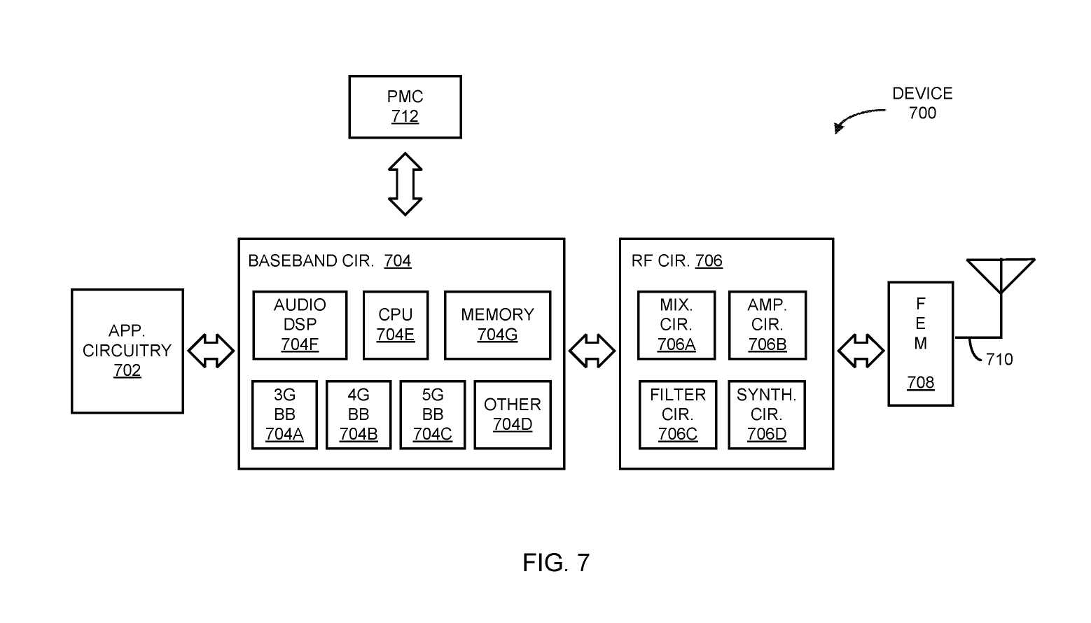

FIG. 7 illustrates example components of a device 700 in accordance with some embodiments. In some embodiments, the device 700 may include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 may be included in a UE or a RAN node. In some embodiments, the device 700 may include less elements (e.g., a RAN node may not utilize application circuitry 702, and instead include a processor/controller to process IP data received from an EPC). In some embodiments, the device 700 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 702 may include one or more application processors. For example, the application circuitry 702 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 700. In some embodiments, processors of application circuitry 702 may process IP data packets received from an EPC.

The baseband circuitry 704 may include circuitry such as, but not limited to, one or more single-core or multi-core processors. The baseband circuitry 704 may include one or more baseband processors or control logic to process baseband signals received from a receive signal path of the RF circuitry 706 and to generate baseband signals for a transmit signal path of the RF circuitry 706. Baseband processing circuitry 704 may interface with the application circuitry 702 for generation and processing of the baseband signals and for controlling operations of the RF circuitry 706. For example, in some embodiments, the baseband circuitry 704 may include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), etc.). The baseband circuitry 704 (e.g., one or more of baseband processors 704A-D) may handle various radio control functions that enable communication with one or more radio networks via the RF circuitry 706. In other embodiments, some or all of the functionality of baseband processors 704A-D may be included in modules stored in the memory 704G and executed via a Central Processing Unit (CPU) 704E. The radio control functions may include, but are not limited to, signal modulation/demodulation, encoding/decoding, radio frequency shifting, etc. In some embodiments, modulation/demodulation circuitry of the baseband circuitry 704 may include Fast-Fourier Transform (FFT), preceding, or constellation mapping/demapping functionality. In some embodiments, encoding/decoding circuitry of the baseband circuitry 704 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 704 may include one or more audio digital signal processor(s) (DSP) 704F. The audio DSP(s) 704F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 704 and the application circuitry 702 may be implemented together such as, for example, on a system on a chip (SOC).

In some embodiments, the baseband circuitry 704 may provide for communication compatible with one or more radio technologies. For example, in some embodiments, the baseband circuitry 704 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 704 is configured to support radio communications of more than one wireless protocol may be referred to as multi-mode baseband circuitry.

RF circuitry 706 may enable communication with wireless networks using modulated electromagnetic radiation through a non-solid medium. In various embodiments, the RF circuitry 706 may include switches, filters, amplifiers, etc. to facilitate the communication with the wireless network. RF circuitry 706 may include a receive signal path which may include circuitry to down-convert RF signals received from the FEM circuitry 708 and provide baseband signals to the baseband circuitry 704. RF circuitry 706 may also include a transmit signal path which may include circuitry to up-convert baseband signals provided by the baseband circuitry 704 and provide RF output signals to the FEM circuitry 708 for transmission.

In some embodiments, the receive signal path of the RF circuitry 706 may include mixer circuitry 706a, amplifier circuitry 706b and filter circuitry 706c. In some embodiments, the transmit signal path of the RF circuitry 706 may include filter circuitry 706c and mixer circuitry 706a. RF circuitry 706 may also include synthesizer circuitry 706d for synthesizing a frequency for use by the mixer circuitry 706a of the receive signal path and the transmit signal path. In some embodiments, the mixer circuitry 706a of the receive signal path may be configured to down-convert RF signals received from the FEM circuitry 708 based on the synthesized frequency provided by synthesizer circuitry 706d. The amplifier circuitry 706b may be configured to amplify the down-converted signals and the filter circuitry 706c may be a low-pass filter (LPF) or band-pass filter (BPF) configured to remove unwanted signals from the down-converted signals to generate output baseband signals. Output baseband signals may be provided to the baseband circuitry 704 for further processing. In some embodiments, the output baseband signals may be zero-frequency baseband signals, although this is not a requirement. In some embodiments, mixer circuitry 706a of the receive signal path may comprise passive mixers, although the scope of the embodiments is not limited in this respect.

In some embodiments, the mixer circuitry 706a of the transmit signal path may be configured to up-convert input baseband signals based on the synthesized frequency provided by the synthesizer circuitry 706d to generate RF output signals for the FEM circuitry 708. The baseband signals may be provided by the baseband circuitry 704 and may be filtered by filter circuitry 706c.

In some embodiments, the mixer circuitry 706a of the receive signal path and the mixer circuitry 706a of the transmit signal path may include two or more mixers and may be arranged for quadrature downconversion and upconversion, respectively. In some embodiments, the mixer circuitry 706a of the receive signal path and the mixer circuitry 706a of the transmit signal path may include two or more mixers and may be arranged for image rejection (e.g., Hartley image rejection). In some embodiments, the mixer circuitry 706a of the receive signal path and the mixer circuitry 706a may be arranged for direct downconversion and direct upconversion, respectively. In some embodiments, the mixer circuitry 706a of the receive signal path and the mixer circuitry 706a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 706 may include analog-to-digital converter (ADC) and digital-to-analog converter (DAC) circuitry and the baseband circuitry 704 may include a digital baseband interface to communicate with the RF circuitry 706.

In some dual-mode embodiments, a separate radio IC circuitry may be provided for processing signals for each spectrum, although the scope of the embodiments is not limited in this respect. In some embodiments, the synthesizer circuitry 706d may be a fractional-N synthesizer or a fractional N/N+1 synthesizer, although the scope of the embodiments is not limited in this respect as other types of frequency synthesizers may be suitable. For example, synthesizer circuitry 706d may be a delta-sigma synthesizer, a frequency multiplier, or a synthesizer comprising a phase-locked loop with a frequency divider.

The synthesizer circuitry 706d may be configured to synthesize an output frequency for use by the mixer circuitry 706a of the RF circuitry 706 based on a frequency input and a divider control input. In some embodiments, the synthesizer circuitry 706d may be a fractional N/N+1 synthesizer.

In some embodiments, frequency input may be provided by a voltage controlled oscillator (VCO), although that is not a requirement. Divider control input may be provided by either the baseband circuitry 704 or the applications processor 702 depending on the desired output frequency. In some embodiments, a divider control input (e.g., N) may be determined from a look-up table based on a channel indicated by the applications processor 702.

Synthesizer circuitry 706d of the RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 706 may include an IQ/polar converter.

FEM circuitry 708 may include a receive signal path which may include circuitry configured to operate on RF signals received from one or more antennas 710, amplify the received signals and provide the amplified versions of the received signals to the RF circuitry 706 for further processing. FEM circuitry 708 may also include a transmit signal path which may include circuitry configured to amplify signals for transmission provided by the RF circuitry 706 for transmission by one or more of the one or more antennas 710. In various embodiments, the amplification through the transmit or receive signal paths may be done solely in the RF circuitry 706, solely in the FEM 708, or in both the RF circuitry 706 and the FEM 708.

In some embodiments, the FEM circuitry 708 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 706). The transmit signal path of the FEM circuitry 708 may include a power amplifier (PA) to amplify input RF signals (e.g., provided by RF circuitry 706), and one or more filters to generate RF signals for subsequent transmission (e.g., by one or more of the one or more antennas 710).

In some embodiments, the PMC 712 may manage power provided to the baseband circuitry 704. In particular, the PMC 712 may control power-source selection, voltage scaling, battery charging, or DC-to-DC conversion. The PMC 712 may often be included when the device 700 is capable of being powered by a battery, for example, when the device is included in a UE. The PMC 712 may increase the power conversion efficiency while providing desirable implementation size and heat dissipation characteristics.

While FIG. 7 shows the PMC 712 coupled only with the baseband circuitry 704. However, in other embodiments, the PMC 712 may be additionally or alternatively coupled with, and perform similar power management operations for, other components such as, but not limited to, application circuitry 702, RF circuitry 706, or FEM 708.

In some embodiments, the PMC 712 may control, or otherwise be part of, various power saving mechanisms of the device 700. For example, if the device 700 is in an RRC_Connected state, where it is still connected to the RAN node as it expects to receive traffic shortly, then it may enter a state known as Discontinuous Reception Mode (DRX) after a period of inactivity. During this state, the device 700 may power down for brief intervals of time and thus save power.

If there is no data traffic activity for an extended period of time, then the device 700 may transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 702 and processors of the baseband circuitry 704 may be used to execute elements of one or more instances of a protocol stack. For example, processors of the baseband circuitry 704, alone or in combination, may be used execute Layer 3, Layer 2, or Layer 1 functionality, while processors of the application circuitry 704 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

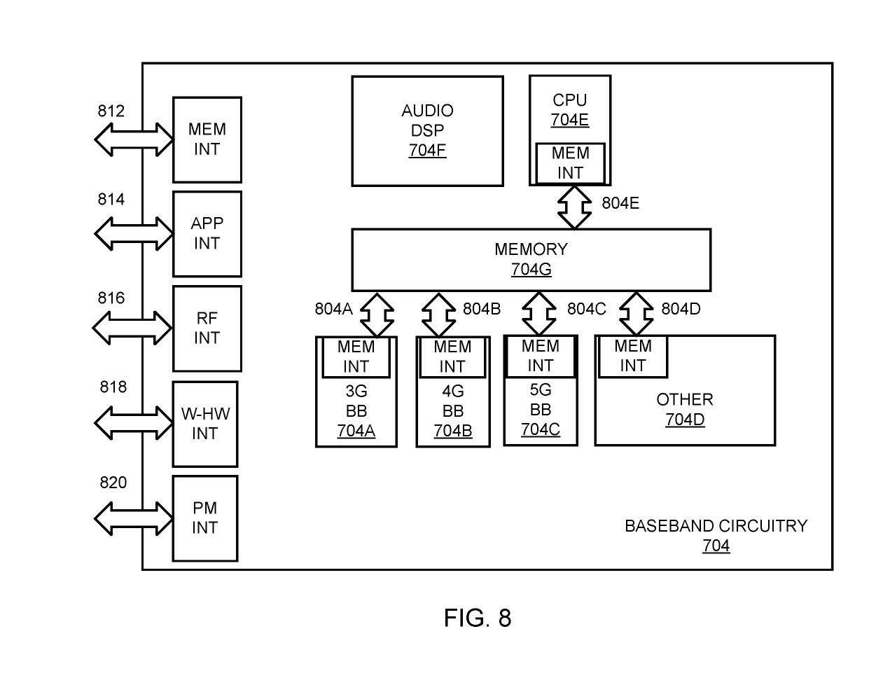

FIG. 8 illustrates example interfaces of baseband circuitry in accordance with some embodiments. As discussed above, the baseband circuitry 704 of FIG. 7 may comprise processors 704A-704E and a memory 704G utilized by said processors. Each of the processors 704A-704E may include a memory interface, 804A-804E, respectively, to send/receive data to/from the memory 704G.

The baseband circuitry 704 may further include one or more interfaces to communicatively couple to other circuitries/devices, such as a memory interface 812 (e.g., an interface to send/receive data to/from memory external to the baseband circuitry 704), an application circuitry interface 814 (e.g., an interface to send/receive data to/from the application circuitry 702 of FIG. 7), an RF circuitry interface 816 (e.g., an interface to send/receive data to/from RF circuitry 706 of FIG. 7), a wireless hardware connectivity interface 818 (e.g., an interface to send/receive data to/from Near Field Communication (NFC) components, Bluetooth® components (e.g., Bluetooth® Low Energy), Wi-Fi® components, and other communication components), and a power management interface 820 (e.g., an interface to send/receive power or control signals to/from the PMC 712.

The following are example implementations of the subject matter described herein. It should be noted that any of the examples and the variations thereof described herein may be used in any permutation or combination of any other one or more examples or variations, although the scope of the claimed subject matter is not limited in these respects.

In example one, an apparatus of a user equipment (UE) comprises one or more baseband processors to generate a message for an evolved NodeB (eNB) to indicate if the UE supports a reduced processing time for Physical Downlink Shared Channel (PDSCH) transmissions to hybrid automatic repeat request (HARQ) and for uplink grants to Physical Uplink Shared Channel (PUSCH) transmissions, and a memory to store the message. Example two may include the subject matter of example one or any of the examples described herein, wherein the message is to be transmitted to the eNB using UE capability indication signaling, and the capability is indicated with a single bit or with multiple bits in the message. Example three may include the subject matter of example one or any of the examples described herein, wherein the message is to be transmitted to the eNB using radio resource control (RRC) signaling. Example four may include the subject matter of example one or any of the examples described herein, wherein the message comprises an RRCConnectionRequest message to be sent as part of an RRC connection establishment procedure. Example five may include the subject matter of example one or any of the examples described herein, wherein the message comprises an RRCConnectionReconfigurationComplete message to be sent as part of an RRC connection reconfiguration procedure. Example six may include the subject matter of example one or any of the examples described herein, wherein the message is generated in response to broadcast signaling comprising a master information block (MIB) or a system information block (SIB) received from the eNB as part of a system information acquisition procedure. Example seven may include the subject matter of example one or any of the examples described herein, wherein the message includes a UE-EUTRA-Capability information element. Example eight may include the subject matter of example one or any of the examples described herein, wherein the message indicates a category of the UE or a release version of a Third Generation Partnership Project (3GPP) standard under which the UE is capable of operating.

In example nine, an apparatus of an evolved NodeB (NB) comprises one or more baseband processors to generate a message for a user equipment (UE) to indicate to the UE if the eNB supports a reduced processing time for Physical Downlink Shared Channel (PDSCH) transmissions to hybrid automatic repeat request (HARQ) and for uplink grants to Physical Uplink Shared Channel (PUSCH) transmissions, and a memory to store the message. Example ten may include the subject matter of example nine or any of the examples described herein, wherein the message is to be transmitted to the UE using radio resource control (RRC) signaling. Example eleven may include the subject matter of example nine or any of the examples described herein, wherein the message is to be transmitted in a system information block (SIB) that is common for all UE devices connected with the eNB. Example twelve may include the subject matter of example nine or any of the examples described herein, wherein the one or more baseband processors are to encode the SIB with information indicating support for the reduced processing time during a random-access procedure. Example thirteen may include the subject matter of example nine or any of the examples described herein, wherein the message comprises an RRCConnectionSetup message to be sent as part of an RRC connection establishment procedure. Example fourteen may include the subject matter of example nine or any of the examples described herein, wherein the message comprises an RRCConnectionReconfiguration message to be sent as part of an RRC connection reconfiguration procedure. Example fifteen may include the subject matter of example nine or any of the examples described herein, wherein the message includes a master information block (MIB) or a system information block (SIB) as part of a system information acquisition procedure. Example sixteen may include the subject matter of example nine or any of the examples described herein, wherein the message includes information to configure the UE to use reduced processing time for HARQ. Example seventeen may include the subject matter of example nine or any of the examples described herein, wherein the message includes information to configure the UE to use asynchronous uplink HARQ. Example eighteen may include the subject matter of example nine or any of the examples described herein, wherein the message includes information to configure the UE to use a reduced round-trip timer (RTT) for HARQ.

In example nineteen, one or more machine-readable media may have instructions stored thereon that, if executed by an apparatus of a user equipment (UE), result in generating a message for an evolved NodeB (eNB) to indicate if the UE supports a reduced processing time for Physical Downlink Shared Channel (PDSCH) transmissions to hybrid automatic repeat request (HARQ) and for uplink grants to Physical Uplink Shared Channel (PUSCH) transmissions, and storing the message in a memory. Example twenty may include the subject matter of example nineteen or any of the examples described herein, wherein the message is to be transmitted to the eNB using UE capability indication signaling, and the capability is indicated with a single bit or with multiple bits in the message. Example twenty-one may include the subject matter of example nineteen or any of the examples described herein, wherein the message is to be transmitted to the eNB using radio resource control (RRC) signaling. Example twenty-two may include the subject matter of example nineteen or any of the examples described herein, wherein the message comprises an RRCConnectionRequest message to be sent as part of an RRC connection establishment procedure. Example twenty-three may include the subject matter of example nineteen or any of the examples described herein, wherein the message comprises an RRCConnectionReconfigurationComplete message to be sent as part of an RRC connection reconfiguration procedure. Example twenty-four may include the subject matter of example nineteen or any of the examples described herein, wherein the message is generated in response to broadcast signaling comprising a master information block (MIB) or a system information block (SIB) received from the eNB as part of a system information acquisition procedure. Example twenty-five may include the subject matter of example nineteen or any of the examples described herein, wherein the message includes a UE-EUTRA-Capability information element. Example twenty-six may include the subject matter of example nineteen or any of the examples described herein, wherein the message indicates a category of the UE or a release version of a Third Generation Partnership Project (3GPP) standard under which the UE is capable of operating.

In example twenty-seven, one or more machine-readable media may have instructions stored thereon that, if executed by an apparatus of an evolved NodeB (NB), result in generating a message for a user equipment (UE) to indicate to the UE if the eNB supports a reduced processing time for Physical Downlink Shared Channel (PDSCH) transmissions to hybrid automatic repeat request (HARQ) and for uplink grants to Physical Uplink Shared Channel (PUSCH) transmissions, and storing the message in a memory. Example twenty-eight may include the subject matter of example twenty-seven or any of the examples described herein, wherein the message is to be transmitted to the UE using radio resource control (RRC) signaling. Example twenty-nine may include the subject matter of example twenty-seven or any of the examples described herein, wherein the message is to be transmitted in a system information block (SIB) that is common for all UE devices connected with the eNB. Example thirty may include the subject matter of example twenty-seven or any of the examples described herein, wherein the instructions, if executed, further result in encoding the SIB with information indicating support for the reduced processing time during a random-access procedure. Example thirty-one may include the subject matter of example twenty-seven or any of the examples described herein, wherein the message comprises an RRCConnectionSetup message to be sent as part of an RRC connection establishment procedure. Example thirty-two may include the subject matter of example twenty-seven or any of the examples described herein, wherein the message comprises an RRCConnectionReconfiguration message to be sent as part of an RRC connection reconfiguration procedure. Example thirty-three may include the subject matter of example twenty-seven or any of the examples described herein, wherein the message includes a master information block (MIB) or a system information block (SIB) as part of a system information acquisition procedure. Example thirty-four may include the subject matter of example twenty-seven or any of the examples described herein, wherein the message includes information to configure the UE to use reduced processing time for HARQ. Example thirty-five may include the subject matter of example twenty-seven or any of the examples described herein, wherein the message includes information to configure the UE to use asynchronous uplink HARQ. Example thirty-six may include the subject matter of example twenty-seven or any of the examples described herein, wherein the message includes information to configure the UE to use a reduced round-trip timer (RTT) for HARQ.

In example thirty-seven, an apparatus of a user equipment (UE) comprises means for generating a message for an evolved NodeB (eNB) to indicate if the UE supports a reduced processing time for Physical Downlink Shared Channel (PDSCH) transmissions to hybrid automatic repeat request (HARQ) and for uplink grants to Physical Uplink Shared Channel (PUSCH) transmissions, and means for storing the message in a memory. Example thirty-eight may include the subject matter of example thirty-seven or any of the examples described herein, wherein the message is to be transmitted to the eNB using UE capability indication signaling, and the capability is indicated with a single bit or with multiple bits in the message. Example thirty-nine may include the subject matter of example thirty-seven or any of the examples described herein, wherein the message is to be transmitted to the eNB using radio resource control (RRC) signaling.

In example forty, an apparatus of an evolved NodeB (NB) comprises means for generating a message for a user equipment (UE) to indicate to the UE if the eNB supports a reduced processing time for Physical Downlink Shared Channel (PDSCH) transmissions to hybrid automatic repeat request (HARQ) and for uplink grants to Physical Uplink Shared Channel (PUSCH) transmissions, and means for storing the message in a memory. Example forty-one may include the subject matter of example forty or any of the examples described herein, wherein the message is to be transmitted to the UE using radio resource control (RRC) signaling. Example forty-two may include the subject matter of example forty or any of the examples described herein, wherein the message is to be transmitted in a system information block (SIB) that is common for all UE devices connected with the eNB. Example forty-three may include the subject matter of example forty or any of the examples described herein, further comprising means for encoding the SIB with information indicating support for the reduced processing time during a random-access procedure. In example forty-four, machine-readable storage includes machine-readable instructions, when executed, to realize an apparatus as claimed in any preceding claim.

In the description herein and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. Coupled, however, may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. It should be noted, however, that “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the description herein and/or claims, the terms “comprise” and “include,” along with their derivatives, may be used and are intended as synonyms for each other.

Although the claimed subject matter has been described with a certain degree of particularity, it should be recognized that elements thereof may be altered by persons skilled in the art without departing from the spirit and/or scope of claimed subject matter. It is believed that the subject matter pertaining to signaling to support reduced processing time and many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1-25. (canceled)

26. An apparatus of a user equipment (UE), comprising:
one or more baseband processors to generate a message for an evolved NodeB (eNB) to indicate if the UE supports a reduced processing time for Physical Downlink Shared Channel (PDSCH) transmissions to hybrid automatic repeat request (HARD) and for uplink grants to Physical Uplink Shared Channel (PUSCH) transmissions; and
a memory to store the message.

27. The apparatus of claim 26, wherein the message is to be transmitted to the eNB using UE capability indication signaling, and the capability is indicated with a single bit or with multiple bits in the message.

28. The apparatus of claim 26, wherein the message is to be transmitted to the eNB using radio resource control (RRC) signaling.

29. The apparatus of claim 28, wherein the message comprises an RRCConnectionRequest message to be sent as part of an RRC connection establishment procedure.

30. The apparatus of claim 28, wherein the message comprises an RRCConnectionReconfigurationComplete message to be sent as part of an RRC connection reconfiguration procedure.

31. The apparatus of claim 26, wherein the message is generated in response to broadcast signaling comprising a master information block (MIB) or a system information block (SIB) received from the eNB as part of a system information acquisition procedure.

32. The apparatus of claim 26, wherein the message includes a UE-EUTRA-Capability information element.

33. The apparatus of claim 26, wherein the message indicates a category of the UE or a release version of a Third Generation Partnership Project (3GPP) standard under which the UE is capable of operating.

34. An apparatus of an evolved NodeB (NB), comprising:
one or more baseband processors to generate a message for a user equipment (UE) to indicate to the UE if the eNB supports a reduced processing time for Physical Downlink Shared Channel (PDSCH) transmissions to hybrid automatic repeat request (HARD) and for uplink grants to Physical Uplink Shared Channel (PUSCH) transmissions; and
a memory to store the message.

35. The apparatus of claim 34, wherein the message is to be transmitted to the UE using radio resource control (RRC) signaling.

36. The apparatus of claim 34, wherein the message is to be transmitted in a system information block (SIB) that is common for all UE devices connected with the eNB.

37. The apparatus of claim 36, wherein the one or more baseband processors are to encode the SIB with information indicating support for the reduced processing time during a random-access procedure.

38. The apparatus of claim 35, wherein the message comprises an RRCConnectionSetup message to be sent as part of an RRC connection establishment procedure.

39. The apparatus of claim 35, wherein the message comprises an RRCConnectionReconfiguration message to be sent as part of an RRC connection reconfiguration procedure.

40. The apparatus of claim 34, wherein the message includes a master information block (MIB) or a system information block (SIB) as part of a system information acquisition procedure.

41. The apparatus of any of claim 34, wherein the message includes information to configure the UE to use reduced processing time for HARQ.

42. The apparatus of claim 34, wherein the message includes information to configure the UE to use asynchronous uplink HARQ.

43. The apparatus of claim 34, wherein the message includes information to configure the UE to use a reduced round-trip timer (RTT) for HARQ.

44. One or more non-transitory machine-readable media having instructions stored thereon that, if executed by an apparatus of a user equipment (UE), result in:
generating a message for an evolved NodeB (eNB) to indicate if the UE supports a reduced processing time for Physical Downlink Shared Channel (PDSCH) transmissions to hybrid automatic repeat request (HARQ) and for uplink grants to Physical Uplink Shared Channel (PUSCH) transmissions; and
storing the message in a memory.

45. The one or more non-transitory machine-readable media of claim 44, wherein the message is to be transmitted to the eNB using UE capability indication signaling, and the capability is indicated with a single bit or with multiple bits in the message.

46. The one or more non-transitory machine-readable media of claim 44, wherein the message is to be transmitted to the eNB using radio resource control (RRC) signaling.

47. One or more machine-readable media having instructions stored thereon that, if executed by an apparatus of an evolved NodeB (NB), result in:
generating a message for a user equipment (UE) to indicate to the UE if the eNB supports a reduced processing time for Physical Downlink Shared Channel (PDSCH) transmissions to hybrid automatic repeat request (HARD) and for uplink grants to Physical Uplink Shared Channel (PUSCH) transmissions; and
storing the message in a memory.

48. The one or more non-transitory machine-readable media of claim 47, wherein the message is to be transmitted to the UE using radio resource control (RRC) signaling.

49. The one or more non-transitory machine-readable media of claim 47, wherein the message is to be transmitted in a system information block (SIB) that is common for all UE devices connected with the eNB.

50. The one or more non-transitory machine-readable media of claim 49, wherein the instructions, if executed, further result in encoding the SIB with information indicating support for the reduced processing time during a random-access procedure.
